(19) United States
(12) Patent Application Publication
(10) Pub. No.: US 2014/0184587 A1
(43) Pub. Date: Jul. 3, 2014

(54) APPARATUS AND METHOD FOR SUPPORTING 3D ULTRASOUND IMAGE ANALYSIS

(71) Applicant: Samsung Electronics Co., Ltd., Suwon-si (KR)

(72) Inventors: Jin-Man PARK, Yongin-si (KR); Kyoung-Gu WOO, Seoul (KR)

(73) Assignee: Samsung Electronics Co., Ltd., Suwon-si (KR)

(21) Appl. No.: 14/074,311

(22) Filed: Nov. 7, 2013

(30) Foreign Application Priority Data
Jan. 2, 2013 (KR) 10-2013-0000302

(51) Int. Cl. G06T 15/00

(52) U.S. Cl. CPC G06T 15/00
USPC 345/419

(57) ABSTRACT

An apparatus and a method are provided to support 3D ultrasonic image analysis. The apparatus includes an object generator configured to perform a 3D outline rendering based on a region of interest (ROI) in an image and generate a 3D object. The apparatus also includes an interface unit configured to display the 3D object, a plane including the ROI on 3D axes of the 3D object, and an additional plane perpendicular to the plane.

### CROSS-REFERENCE TO RELATED APPLICATION(S)

This application claims the benefit under 35 U.S.C. §119(a) of Korean Patent Application No. 10-2013-0000302, filed on Jan. 2, 2013, in the Korean Intellectual Property Office, the entire disclosure of which is incorporated herein by reference for all purposes.

### BACKGROUND

1. Field

The following description relates to an apparatus and a method to support 3-dimensional (3D) ultrasound image analysis.

2. Description of the Related Art

Generally, three-dimensional (3D) medical imaging devices acquire volume data according to a region of interest (ROI), and provide 3D ultrasound images formed by rendering the volume data for medical personnel. If it is possible to equally acquire high-resolution volume data, like how computed tomography (CT scan) and magnetic resonance imaging (MRI) perform, volume data is acquired by being scanned all at once. Subsequently, a method to analyze the acquired volume data in two-or three-dimensions is used.

However, in 3D ultrasonic medical imaging devices to diagnose in real-time through a probe, a quality of volume data in a target region is determined according to a focused region and a focused direction based on ROI. Thus, to acquire high-quality images for a correct diagnosis, the focused region and the focused direction based on the ROI needs to be accurately detected. In general, in an ultrasonic imaging diagnosis that uses a probe, the detection of the focused region and the focused direction is not suitable for 3D images because the detection is performed through an image interface and a probe controller, considering only analyzing two-dimensional (2D) images.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In accordance with an example, there is provided an apparatus to support image analysis. The apparatus includes an object generator configured to perform a 3D outline rendering based on a region of interest (ROI) in an image and generate a 3D object; and an interface unit configured to display the 3D object, a plane including the ROI on 3D axes of the 3D object, and an additional plane perpendicular to the plane.

The apparatus also includes a region of interest (ROI) adjustment unit configured to adjust the ROI according to an input operation.

The input operation includes at least one of moving of the 3D axes of the 3D object, rotating of the 3D axes to a new ROI, and enlarging, reducing, cutting and setting a region boundary of the new ROI.

The interface unit is further configured to display a marker to enable a user to execute the input operation through an input device on an interface.

The interface unit displays a movement or a rotation of the plane on the interface unit in response to the input operation of to move the 3D axes to the new ROI or to rotate the 3D axes.

The interface unit displays an enlargement or a reduction of the new ROI on the interface in response to the input operation to enlarge or to reduce the new ROI.

In response to the ROI being adjusted, the ultrasonic measuring device is further configured to acquire 3D volume data of the adjusted ROI by adjusting a beam-forming setting to focus on the adjusted ROI.

In response to the input operation continuing over a length of time, the ROI adjustment unit is further configured to adjust the ROI by the length of time.

The apparatus also includes an input device configured to enable a user to provide the input operation and including at least one of a finger, a touch pen, a mouse and the ultrasonic measuring device.

The interface unit is further configured to display a two-dimensional (2D) slice image of the 3D volume data, in response to 3D volume data being acquired, and further includes an ROI setting unit configured to set the ROI in the 2D slice image based on input information from a user or input information from a Computer Aided Diagnosis (CAD) system.

In accordance with an illustrative example, there is provided a method to support image analysis. The method includes performing a 3D outline rendering based on a region of interest (ROI) in an image to generate a 3D object; displaying the 3D object on an interface; and displaying a plane including the ROI on 3D axes of the 3D object and another plane perpendicular to the plane.

The method also includes adjusting the region of interest (ROI) according to an input operation.

The method includes displaying of a marker to enable a user to enter the input operation including at least one of moving of the 3D axes of the 3D object, rotating of the 3D axes to a new ROI, and enlarging, reducing, cutting and setting a region boundary of the new ROI.

The method also includes in response to the input operation directing to move or rotate the 3D axes, displaying rotating a movement or a rotation of the plane on the interface according to the input operation.

The method further includes displaying an enlargement or a reduction of the new ROI in response to the input operation to enlarge or to reduce the new ROI.

In response to the ROI being adjusted, the method further includes acquiring 3D volume data according to the adjusted ROI, after the ultrasonic measuring device adjusts a beam-forming setting to focus on the adjusted ROI.

In response to the input operation continuing over a length of time, the method includes the adjusting of the ROI continues for the length of time.

The method also includes in response to 3D volume data being acquired, displaying a two-dimensional (2D) slice image of the 3D volume data; and setting the ROI in the 2D slice image based on input information from a user or input information from a Computer Aided Diagnosis (CAD) system.

In accordance with an illustrative example, there is provided an apparatus, including a generator configured to acquire three-dimensional (3D) volume data in real-time from a region of interest (ROI) on a patient and render a 3D outline based on the ROI to generate a 3D object; and an interface configured to display the 3D objects and planes perpendicular to a plane on a 3D axis of the 3D object.

The interface unit is further configured to display a marker to enable a user to at least one of move axes, rotate, and adjust a size of the 3D object.

The interface unit is further configured to enable a selection of the ROI, receive volume data from an ultrasonic measuring device, and display a two-dimensional (2D) slice image of the volume data in real-time.

The apparatus also includes an ROI adjustment unit configured to adjust the ROI based on an operation from a user at a point in time through an interface.

Other features and aspects may be apparent from the following detailed description, the drawings, and the claims.

### BRIEF DESCRIPTION OF THE DRAWINGS

FIG. 1 is a diagram illustrating an example of an apparatus to support 3D ultrasonic image analysis, in accordance with an embodiment;

FIGS. 2A, 2B, and 2C are diagrams illustrating examples of an interface provided by an apparatus to support 3D ultrasonic image analysis, in accordance with an embodiment; and

FIG. 3 is a flowchart illustrating an example of a method to support 3D ultrasonic image analysis, in accordance with an embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness. Throughout all descriptions of the specification, an identical reference number refers to an identical component.

Examples of an apparatus and method for supporting three-dimensional (3D) ultrasonic image analysis are provided hereafter in detail, referring to figures as illustrated.

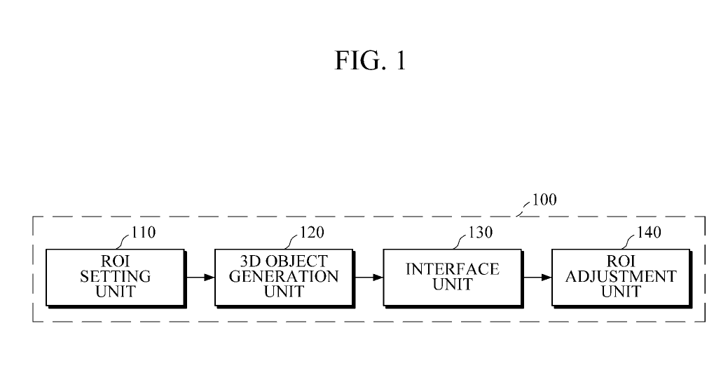

FIG. 1 is a diagram illustrating an example of an apparatus for supporting 3D ultrasonic image analysis, in accordance with an embodiment.

Referring to FIG. 1, the apparatus to support a 3D ultrasonic image analysis 100 includes a region of interest (ROI) setting unit 110, a 3D object generation unit 120, an interface unit 130, and an ROI adjustment unit 140.

An ultrasonic measuring device, including a probe, forms a beam using beam forming information including a predetermined focused direction, a predetermined focused region, and a frequency, etc., and acquires 3D volume data in real-time after scanning a patient's diseased area or patient's area of interest and transmits the acquired 3D volume data to the apparatus 100.

An interface unit 130 provides an interface configured to enable input commands for various operations. For example, a touch input is available on a display of the interface unit 130. An operator or a user of the 3D ultrasonic image analysis 100 may click, or double-click, drag and enlarge, reduce the display using fingers, a touch pen, or a mouse. Also, various operations, such as those mentioned above, may be executed through a processor or a controller equipped in the ultrasonic measuring device. The user may select the ROI through the interface unit 130. The pinch-to-zoom operation may be available to enlarge and reduce the ROI, and when double-clicking is executed, the ROI may be enlarged or reduced as a size set in advance, centrally based on the clicked area. Additionally, other various operations may be available in addition to the operations mentioned above.

According to a configuration, after the ultrasonic measuring device acquires the volume data, the ultrasonic measuring device transmits the volume data to the interface unit 130. The interface unit 130 displays a two-dimensional (2D) slice image of the volume data in real-time.

When the information about the ROI included in the 2D slice image, namely, an area likely to be a diseased or injured area, is received from a Computer Aided Diagnosis (CAD) system, an ROI setting unit 110 sets-up the ROI within the 2D slice image based on the information.

Also, when the user executes a predetermined operation to set, select, or define the ROI using an input device through the interface unit 130, the ROI setting unit 110 sets the ROI based on the input information according to the predetermined operation.

When the ROI is defined, a 3D object generation unit 120 or a 3D generator 120 generates the 3D object by performing a 3D outline rendering based on the ROI. At this time, the 3D object may be a sphere, and the ROI may be shown on a certain plane, for example, on an X-Y plane, formed by X, Y and/or Z axes of the sphere.

The interface unit 130 displays the generated 3D object on the interface provided to the user. Also, the interface unit 130 displays a plane, for example, an X-Y plane, including the ROI. The interface unit 130 also displays planes, for example, a Y-Z plane and an X-Z plane, perpendicular to a plane on the 3D axis of the 3D object.

Moreover, the interface unit 130 displays a predetermined marker to help the user to execute various operations on the interface through the input device. For example, the marker may move the axes up or down, or rotate the axes clockwise or counter-clockwise. Also, the marker may be used to adjust the enlargement or reduction ratio.

An ROI adjustment unit 140 adjusts the ROI based on a predetermined operation, which the user inputs, enters, or directs to be executed through the interface via the input device. The ROI adjustment unit 140 adjusts the ROI at a point in time that the predetermined operation is entered on the interface. For example, in case of being set in advance, when the operation continues over a predetermined length of time, the ROI adjustment unit 140 adjusts the ROI by the predetermined length of time. In one example, when the predetermined length of time is set very short, the ROI may be adjusted in real-time.

Also, the user may move or rotate the axes to a new ROI on the interface where the 3D object and planes are shown. For example, in case that an area likely to be the diseased or injured area exists on an upper side of the 3D object, the user moves the axes of the displayed planes up and sets or defines a part of the upper side of the 3D object to become a center of the axes as the ROI. Also, in case that an area likely to be the diseased area or the injured area exists on left and right sides or a back side of the 3D object, the user may place the area likely to be the diseased area or the injured area to a predetermined location by rotating the axes of the relevant planes and set the area likely to be the diseased area or the injured area as a ROI. The predetermined location may be a front of the interface.

Also, the user may adjust a size of the ROI to be enlarged or reduced through the pinch-to-zoom, the scrolling of a mouse, the controller of the ultrasonic measuring device, or the like.

In addition, when the area likely to be the diseased area exists on a plane of the 3D object, the user may draw a line on the plane of the 3D object using the input device, and set an ROI on a slice of the plane, which is defined by the line.

However, the apparatus to support the 3D ultrasonic image analysis 100 may enable the user to perform other functions, such as enabling the user to set or define a boundary according to the area likely to be diseased area of the 3D object, and update or newly set or define an inside of the boundary as ROI.

As previously described, the ROI adjustment unit 140 may adjust the existing ROI to an ROI which is newly defined or updated according to the user's various operations through the interface. Also, the ultrasonic measuring device may execute beam-forming again according to the adjusted ROI. The ultrasonic measuring device may execute beam-forming again to focus on the newly adjusted ROI or updated ROI, and may acquire the volume data by scanning the patient's diseased area.

Furthermore, the interface unit 130 may display content in response to the user adjusting the ROI on the interface. For example, when the user moves the axes to the new ROI or rotates the axes, a process of the planes being moved or rotated may be displayed in accord with the user moving the axes. Also, in response to the user enlarging or reducing a new ROI, a process of the new ROI being enlarged or reduced on the planes may be displayed.

The units and apparatuses described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of the ROI setting unit 110, the 3D object generation unit 120, the interface unit 130, and the ROI adjustment unit 140 are used as singular; however, one skilled in the art will appreciated that each unit may include multiple processing elements and multiple types of processing elements. For example, a hardware component may include multiple processors or a processor and a controller. In addition, different processing configurations are possible, such a parallel processors.

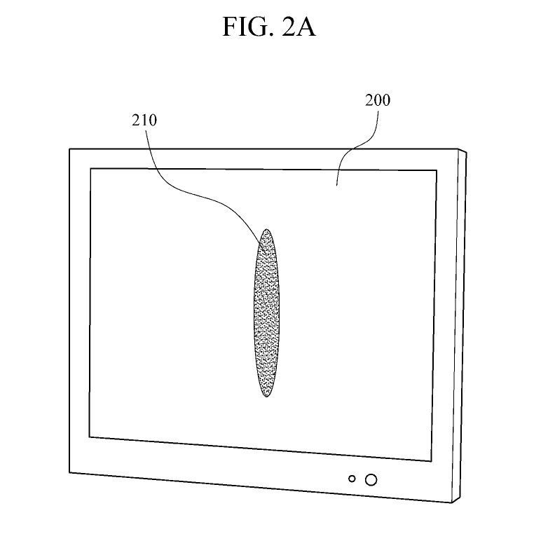

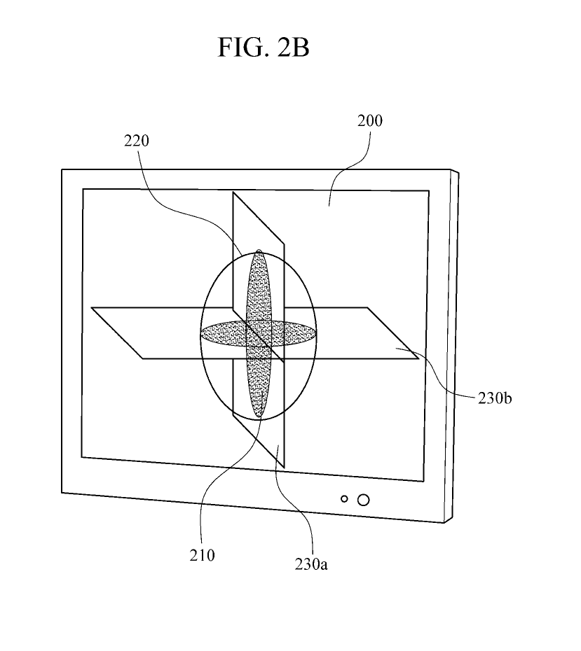

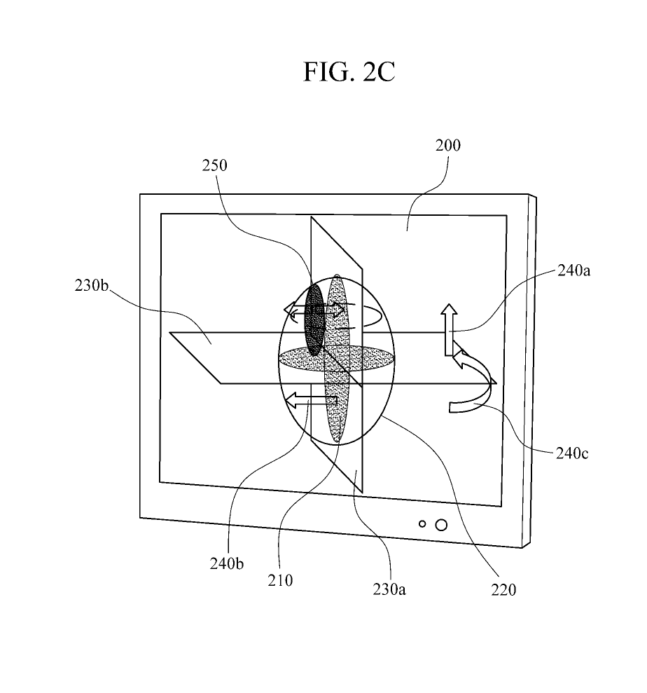

FIG. 2A to 2C are diagrams illustrating examples of an interface provided by an apparatus to support 3D ultrasonic image analysis, in accord with an embodiment. Examples of the apparatus to support 3D ultrasonic image analysis 100 will now be described with reference to FIGS. 2A to 2C.

As illustrated in FIG. 2A, the interface unit 130 may include an interface 200 to display images. As mentioned above, the various operations may be executed on the interface 200. Also, the ultrasonic measuring device acquires the volume data by executing beam-forming based on beam-forming information, such as the pre-set focused direction, pre-set focused region, etc. The ultrasonic measuring device then transmits the acquired volume data to the interface unit 130. In one example, the interface unit 130 displays a 2D slice image acquired from the volume data in real-time.

On the interface 200, in response to the user executing the pre-set operations of dragging, clicking and the like, and setting a position or a size of the area likely to be the diseased area, the ROI setting unit 110 sets or defines an ROI 210 based on the information of the position, the size, etc. of the area likely to be the diseased area or injured area. Alternatively, the information about the area likely to be the diseased area may be input from a CAD diagnostic system.

Referring to FIG. 2B, the 3D object generation unit 120 generates the 3D object 220 by performing the 3D outline rendered based on the set ROI 210.

The interface unit 130 displays the generated 3D object on the interface 200, and displays the three planes perpendicular to each other, which are formed by the X, Y, and Z axes of the 3D object 220, for instance, a X-Y plane 230a, a X-Z plane 230b and a Y-Z plane (not illustrated) being overlapped inside the 3D object 220. Also, the ROI 210 set on the X-Y plane 230a is displayed.

Referring to FIG. 2C, the interface unit 130 may additionally display markers 240a, 240b, and 240c to help the user easily execute various operations. For example, an up-and-down move marker 240a, a left-and-right move marker 240b and a front-and-back move marker (not illustrated), would be displayed enable a user to move the axes up and down, left and right, and front and back. Also, the rotation marker 240c is displayed to rotate the axes in each direction. Although not illustrated in FIG. 2B, the interface 200 may display a marker enabling the user to enlarge or reduce a predetermined region.

The interface unit 130 displays the markers using various graphic objects, and display a movement or rotation of corresponding directions through arrows as an example illustrated in FIG. 2B.

The user may click the up-and-down move marker 240a, the left-and-right move marker 240b, the front-and-back marker (not illustrated), or move the axes up and down, left and right, front and back by moving the markers in particular directions holding down on the click. The interface unit 130 may change the direction of the marker to the opposite direction if it is determined that any of axes is moved to the end of each direction. Also, the user may rotate the axes in particular directions using the rotation marker 240c. At this time, the axes may be set-up to be moved in the range of a 3D object 220.

Furthermore, the user may execute operations to move and rotate the axes, and enlarge and reduce a particular region, etc., on the interface directly through an input device, such as a mouse or stylus, without using the markers.

As mentioned above, the ROI adjustment unit 140 adjusts the ROI 210 based on the user's input on the interface 200. In other words, as the result of analyzing the displayed image on the interface 200, in case that a new ROI 250 is to be considered as the diseased area, the ROI adjustment unit 140 enables the user to move the axes up and left and set the new ROI 250. At this time, the user may adjust an angle of a view through the rotation of the axes, and adjust the size of the new ROI 250 by enlarging or reducing.

If the ROI is adjusted by the ROI adjustment unit 140, namely, information about the position, size, and view direction of the ROI, etc., the ultrasonic measuring device executes the beam-forming again to focus on the adjusted ROI 250 based on the adjusted information and acquires the volume data by scanning the patient's diseased area.

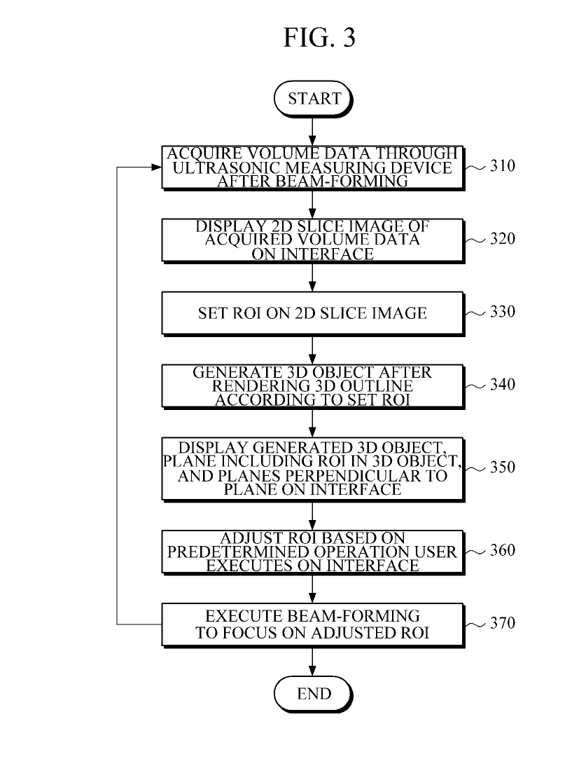

FIG. 3 is a flowchart illustrating an exemplary method for supporting 3D ultrasonic image analysis, in accordance with an embodiment.

Referring to the exemplary examples illustrated in FIG. 1, a method executed by the apparatus to support 3D ultrasonic image analysis 100 will be described hereafter with reference to FIG. 3.

At operation 310, the method acquires volume data in real-time and through an ultrasonic measuring device after executing beam-forming based on beam-forming information, such as a pre-set focused direction, a pre-set focused region, and a frequency.

At operation 320, the method transmits the volume data to the interface unit 130 to display a 2D slice image of the volume data in real-time.

At operation 330, the method is configured to set an area likely to be the diseased area or injured data within the 2D slice image as an ROI. For example, in response to information about the area likely to be the diseased area is input from a CAD system, the method sets the ROI in the 2D slice image based on the input information. In response to the input information of the area likely to be the diseased area and the size of the area, the method sets the ROI based on the input information.

At operation 340, the method generates a 3D object by performing a 3D outline rendering based on the generated ROI. At operation 350, the method displays on the interface unit 130 the generated 3D object and both a plane, for example, a X-Y plane, of the 3D object including the ROI displayed on the 3D axes of the 3D object and other planes, for example, a Y-Z plane, a X-Z plane, perpendicular to the plane.

At operation 360, in response to the user executing a predetermined operation on the interface through an input means, the method adjusts the ROI. In one example, an adjustment of the ROI is executed at the time when the operation of the user finishes on the interface; however, in a case where the operation continues over a predetermined length of time, the method may adjust the ROI for the predetermined length of time. The user is enabled to adjust and set information of a position of the ROI to a new position by moving the axes on the interface, and is enabled to input information of an angle of viewing of the ROI through executing an operation of rotating. Also, the information of the size of a new ROI may be adjusted by enlarging or reducing the new ROI.

In response to the ROI being newly adjusted or updated, at operation 370, the method executes the beam-forming again to focus on the adjusted ROI. The method executes the beam-forming again, thereby scanning the patient's diseased area and repeatedly executing the processing from operation 310 until the diagnosis is finished at operation 370.

According to the examples described above, the beam-forming information of the focused direction and focused region of the apparatus supporting three-dimensional (3D) ultrasonic image of FIG. 1 and the method of FIG. 3 may be revised in real-time to focus on the ROI adjusted by the user, and a high-resolution image may be possibly acquired according to the ROI by re-executing the process of the beam-forming in real-time based on the revised information, thereby improving accuracy of a user's medical image analysis.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like.

Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner. Also, functional programs, codes and code segments to implement those embodiments may be easily inferred by programmers who are skilled in the related art.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus to support image analysis, comprising:
an object generator configured to perform a 3D outline rendering based on a region of interest (ROI) in an image and generate a 3D object; and
an interface unit configured to display the 3D object, a plane including the ROI on 3D axes of the 3D object, and an additional plane perpendicular to the plane.

2. The apparatus of claim 1, further comprising:
a region of interest (ROI) adjustment unit configured to adjust the ROI according to an input operation.

3. The apparatus of claim 2, wherein the input operation comprises at least one of moving of the 3D axes of the 3D object, rotating of the 3D axes to a new ROI, and enlarging, reducing, cutting and setting a region boundary of the new ROI.

4. The apparatus of claim 3, wherein the interface unit is further configured to display a marker to enable a user to execute the input operation through an input device on an interface.

5. The apparatus of claim 3, wherein the interface unit displays a movement or a rotation of the plane on the interface unit in response to the input operation of to move the 3D axes to the new ROI or to rotate the 3D axes.

6. The apparatus of claim 3, wherein the interface unit displays an enlargement or a reduction of the new ROI on the interface in response to the input operation to enlarge or to reduce the new ROI.

7. The apparatus of claim 2, wherein, in response to the ROI being adjusted, the ultrasonic measuring device is further configured to acquire 3D volume data of the adjusted ROI by adjusting a beam-forming setting to focus on the adjusted ROI.

8. The apparatus of claim 7, wherein, in response to the input operation continuing over a length of time, the ROI adjustment unit is further configured to adjust the ROI by the length of time.

9. The apparatus of claim 2, further comprising:
an input device configured to enable a user to provide the input operation and comprising at least one of a finger, a touch pen, a mouse and the ultrasonic measuring device.

10. The apparatus of claim 1, wherein the interface unit is further configured to display a two-dimensional (2D) slice image of the 3D volume data, in response to 3D volume data being acquired, and
further comprising:
an ROI setting unit configured to set the ROI in the 2D slice image based on input information from a user or input information from a Computer Aided Diagnosis (CAD) system.

11. A method to support image analysis, comprising:
performing a 3D outline rendering based on a region of interest (ROI) in an image to generate a 3D object;
displaying the 3D object on an interface; and
displaying a plane including the ROI on 3D axes of the 3D object and another plane perpendicular to the plane.

12. The method of claim 11, further comprising:
adjusting the region of interest (ROI) according to an input operation.

13. The method of claim 12, further comprising:
displaying of a marker to enable a user to enter the input operation comprising at least one of moving of the 3D axes of the 3D object, rotating of the 3D axes to a new ROI, and enlarging, reducing, cutting and setting a region boundary of the new ROI.

14. The method of claim 13, further comprising:
in response to the input operation directing to move or rotate the 3D axes, displaying rotating a movement or a rotation of the plane on the interface according to the input operation.

15. The method of claim 13, further comprising:
displaying an enlargement or a reduction of the new ROI in response to the input operation to enlarge or to reduce the new ROI.

16. The method of claim 12, further comprising:
in response to the ROI being adjusted, acquiring 3D volume data according to the adjusted ROI, after the ultrasonic measuring device adjusts a beam-forming setting to focus on the adjusted ROI.

17. The method of claim 16, wherein, in response to the input operation continuing over a length of time, the adjusting of the ROI continues for the length of time.

18. The method of claim 11, further comprising:
in response to 3D volume data being acquired,
displaying a two-dimensional (2D) slice image of the 3D volume data; and
setting the ROI in the 2D slice image based on input information from a user or input information from a Computer Aided Diagnosis (CAD) system.

19. An apparatus, comprising:
a generator configured to acquire three-dimensional (3D) volume data in real-time from a region of interest (ROI) on a patient and render a 3D outline based on the ROI to generate a 3D object; and
an interface configured to display the 3D objects and planes perpendicular to a plane on a 3D axis of the 3D object.

20. The apparatus of claim 19, wherein the interface unit is further configured to display a marker to enable a user to at least one of move axes, rotate, and adjust a size of the 3D object.

21. The apparatus of claim 19, wherein the interface unit is further configured to enable a selection of the ROI, receive volume data from an ultrasonic measuring device, and display a two-dimensional (2D) slice image of the volume data in real-time.

22. The apparatus of claim 19, further comprising:
an ROI adjustment unit configured to adjust the ROI based on an operation from a user at a point in time through an interface.
